(19) United States
(12) Patent Application Publication
(10) Pub. No.: US 2012/0123870 A1
(43) Pub. Date: May 17, 2012

(54) SYSTEMS AND METHODS FOR ENABLING PERSONALIZATION OF DATA SERVICE PLANS

(75) Inventors: Robert E. Denman, Plano, TX (US); Frederick C. Kemmerer, Hollis, NH (US)

(73) Assignee: GENBAND INC., Plano, TX (US)

(21) Appl. No.: 13/222,807

(22) Filed: Aug. 31, 2011

Related U.S. Application Data
(60) Provisional application No. 61/414,272, filed on Nov. 16, 2010.

(51) Int. Cl. G06Q 30/00; G06F 15/173

(52) U.S. Cl. 705/14.66; 705/14.49; 705/14.4; 709/223

(57) ABSTRACT

Systems and methods for enabling personalization of data service plans are disclosed herein. According to an aspect, a method can include receiving profile and network usage data of a subscriber. Further, the method can include generating a personalized data service offer for the subscriber based on the profile and network usage data. The method can also include presenting the personalized data service offer to the subscriber. The subscriber may respond to accept the offer.

### CROSS REFERENCE TO RELATED APPLICATION

This application claims the benefit of U.S. provisional patent application No. 61/414,272, filed Nov. 16, 2010, the content of which is hereby incorporated herein by reference in its entirety.

### TECHNICAL FIELD

The presently disclosed subject matter relates to communications networks. Particularly, the presently disclosed subject matter relates to providing data service plans to subscribers to network services.

### BACKGROUND

Internet service providers have faced difficulties in offering profitable data service plans. Various plans providing unlimited data usage have led to decoupling of traffic (with associated costs) and revenues.

Several existing solutions have sought to shore up Internet data service plan revenues and better align revenues with data usage. For example, various tiered services exist that are based on bandwidth or traffic volume. Other services, for example, may provide low-latency plans for gamers. However, a subscriber to such existing services must choose from only a handful of pre-provisioned service plans. These plans may not be well-aligned to the subscriber's historical and planned access to Internet Protocol (IP)-based content and services, and cannot adapt to the subscriber's changing usage patterns. In the interest of both maximizing data service plan revenues and minimizing subscriber churn with personally relevant data services, mass personalization of data service plans is needed. But marketing and provisioning costs of personalized data service plans have thus far impeded their introduction into the marketplace.

Accordingly, in view of the foregoing, improved systems and methods are needed for personalizing data service plans.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for enabling personalization of data service plans. According to an aspect, a method can include receiving profile and network usage data of a subscriber. Further, the method can include automatically generating a personalized data service offer for the subscriber based on the profile and network usage data. The method can also include automatically presenting the personalized data service offer to the subscriber.

According to another aspect, a method can include communicating to a subscriber a data service generation offer. The method can also include receiving a communication from the subscriber indicating acceptance of the data service generation offer. Further, the method can include generating a personalized data service offer and presenting the personalized data service offer to the subscriber in response to receiving the communication indicating acceptance of the data service generation offer. The personalized data service offer can include one or more persistent, personalized data service plans.

According to another aspect, a method can include receiving profile and network usage data of a subscriber. The method can also include generating a personalized data service offer for the subscriber based on the profile and network usage data. The personalized data service offer can define a content filtering service for the subscriber. Further, the method can include presenting the personalized data service offer and content filtering service to the subscriber.

According to yet another aspect, a method can include storing status information of a personalized data service offer for a subscriber. Further, the method can include managing actions of network elements associated with the personalized data service offer by use of the stored status information.

According to another aspect, a method can include communicating to a subscriber a data service generation offer. The method can also include receiving a communication from the subscriber indicating acceptance of the data service generation offer. Further, the method can include triggering capture of network usage data of the subscriber in response to receiving the communication indicating acceptance of the data service generation offer.

According to yet another aspect, a method can include receiving profile and network usage data of a subscriber. The method can also include generating a personalized data service offer for the subscriber based on the profile and network usage data. The personalized data service offer defines limits on traffic associated with the peer-to-peer applications. Further, the method can include presenting the personalized data service offer and the network usage data to the subscriber.

According to another aspect, a method can include storing status information of a personalized data service offer for a subscriber. The method can also include managing actions of network elements associated with the personalized data service offer by use of the stored status information.

According to another aspect, a method can include receiving profile and network usage data of a subscriber. The method can also include generating a set of personalized data service offerings to persistently modify a data subscription. Further, the method can include presenting the offerings to a subscriber.

According to another aspect, a method can include determining an attempt at network access by a subscriber. The method can also include redirecting the subscriber to a portal for presentation of a personalized data service offer in response to determining the attempt at network access. Alternatively, the method can include redirecting the subscriber to a portal for presentation of an offer to generate a personalized data service offer. In an example, a data service generation offer may be communicated to the subscriber. Further, in this example, the subscriber may accept the generation offer, and a personalized data services offer may be generated and presented in response to acceptance of the generation offer.

The presently disclosed subject matter may be implemented in software in combination with hardware and/or firmware. For example, the presently disclosed subject matter may be implemented in software executed by one or more processors. In an exemplary implementation, the presently disclosed subject matter may be implemented using a non-transitory computer readable medium having stored thereon executable instructions that when executed by the processor of a computer controls the processor to perform steps. Exemplary non-transitory computer readable media suitable for implementing the presently disclosed subject matter include chip memory devices or disk memory devices accessible by a processor, programmable logic devices, and application specific integrated circuits. In addition, a computer readable medium that implements the presently disclosed subject matter may be located on a single computing platform or may be distributed across plural computing platforms.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a network diagram of an example system for enabling personalization of a data service plan in accordance with embodiments of the present disclosure;

FIGS. 2A, 2B, 2C, and 2D are a flow chart of an example method for enabling personalization of a data service plan in accordance with embodiments of the present disclosure;

FIG. 3 depicts a proposal-status finite state machine in accordance with embodiments of the present disclosure;

FIG. 4 is a network diagram of another example system for enabling personalization of a data service plan in accordance with embodiments of the present disclosure;

FIG. 5 is a network diagram of another example system for enabling personalization of a data service plan in accordance with embodiments of the present disclosure;

FIG. 6 is a display screen with which a subscriber may interact for opting into a personalized data service offer in accordance with embodiments of the present disclosure;

FIG. 7 is a display screen presenting a personalized data service offer defining multiple personalized data service plans in accordance with embodiments of the present disclosure;

FIG. 8 is a display screen presenting information about a premium video viewing service option in accordance with embodiments of the present disclosure;

FIG. 9 is a display screen presenting information offering to upgrade a subscriber plan to another bandwidth tier in accordance with embodiments of the present disclosure;

FIG. 10 is a display screen offering usage-management controls for a tiered data usage plan in accordance with embodiments of the present disclosure; and

FIG. 11 is a display screen presenting parental controls in accordance with embodiments of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “user equipment” should be broadly construed. It can include any type of device capable of communicating with a communications network. A user of user equipment may be a subscriber to data services (e.g., Internet service) provided by a service provider. User equipment may be a mobile device such as, for example, but not limited to, a smart phone, a cell phone, a pager, a personal digital assistant (PDA, e.g., with GPRS NIC), a mobile computer with a smart phone client, or the like. An electronic device can also include any type of conventional computer, for example, a desktop computer or a laptop computer. A typical mobile device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, WiFi, EDGE and other 2G, 3G, 4G and LTE technologies, and it operates with many handheld device operating systems, such as PalmOS, EPOC, Windows CE, FLEXOS, OS/9, JavaOS, iOS and Android. Communication may also be implemented over fixed broadband and cable technologies. Typically, these devices use graphical displays and can access the Internet (or other communications network) on so-called any suitable web browser, or mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on an e-book reader, the examples may similarly be implemented on any suitable electronic device, such as a computer or smart phone.

As referred to herein, a “user interface” is generally a system by which users interact with user equipment. An interface can include an input for allowing users to manipulate user equipment, and can include an output for allowing the system to present information (e.g., e-book content) and/or data, indicate the effects of the user's manipulation, etc. An example of an interface on user equipment includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. The display object can be displayed on a display screen of user equipment and can be selected by and interacted with by a user using the interface. In an example, the display of the user equipment can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or arrow keys for moving a cursor to highlight and select the display object.

As referred to herein, an “administrative function” may represent back-office and customer contact center operations, providing operator control over personalized plan proposal services as disclosed herein.

As referred to herein, “subscriber data” may represent one or more network elements providing storage of current user profile, including current subscription options and user authentication data and user device configuration data. Subscriber data may present interfaces to other network elements for retrieval and manipulation of subscriber data, and may propagate subscriber policy and subscription changes to other network elements having a need to know. Enhanced to contain personalized-plan-proposal service state information, subscriber data may be a primary means for managing the service and for integration into the existing back office. Subscriber data may be realized in network deployments as one or more of the following: a 3GPP, 3GPP2 or Broadband Forum (BBF) Authentication, Authorization, and Accounting (AAA) server, a 3GPP or 3GPP2 Home Subscriber Server (HSS), a 3GPP or 3GPP2 Subscriber Policy Repository (SPR), a DHCP server, a proprietary policy repository associated with a DPI inline engine, or a TISPAN User Profile Server Function (UPSF).

As referred to herein, an “inline engine” may include deep packet inspection (DPI) capabilities, including the abilities, for selected IP addresses (subscribers), to generate traffic statistics and enforce redirection policies. The inline engine may be a standalone DPI network element or may be integrated into an access gateway, such as a Broadband Remote Access Server (BRAS), Broadband Network Gateway (BNG), Cable Modem Termination System (CMTS), Packet Data Network (PDN) Gateway, Gateway GPRS Serving Node (GGSN), Home Agent, Packet Data Serving Node (PDSN), or the like.

As referred to herein, a “subscriber manager” may tap into, proxy, or otherwise process signaling by which a user's identity may be associated with (bound to) an IP address, retrieve subscription-related policies from Subscriber Data for the user, and install these policies on the inline engine for enforcement. Policies may dictate redirection of traffic and/or collection of traffic statistics for the user. The subscriber manager may be realized as one or more of a 3GPP Policy and Charging Rules Function (PCRF), a proprietary policy server associated with the Inline Engine, a AAA server, an HSS or USPF, or some other server or interacting combination of network elements.

As referred to herein, a “statistics collector” may be a database or repository for storage of user-associated traffic statistics.

As referred to herein, a “site categorization” component may be a database that associates web sites with subjects (e.g., pornography, personals, gambling) and/or classifications (adult only, child-safe).

As referred to herein, a “personalized marketing preparation function” may prepare sets of personalized, data service plan proposals for presentation to a specific user, using the following as inputs: current subscription information, traffic statistics, portfolio of available data services offered by the operator, rules for building proposals, and possibly site categorization.

As referred to herein, a “customized service options database” may store proposals to be presented to a user or subscriber.

As referred to herein, a “personalized plan portal” may present proposals to a user or subscriber, interact with user to obtain proposal feedback, and initiate propagation to other network elements any status related to user-approved proposal generation or user-approved subscription changes. The personalized plan portal may be implemented in a web server, for example.

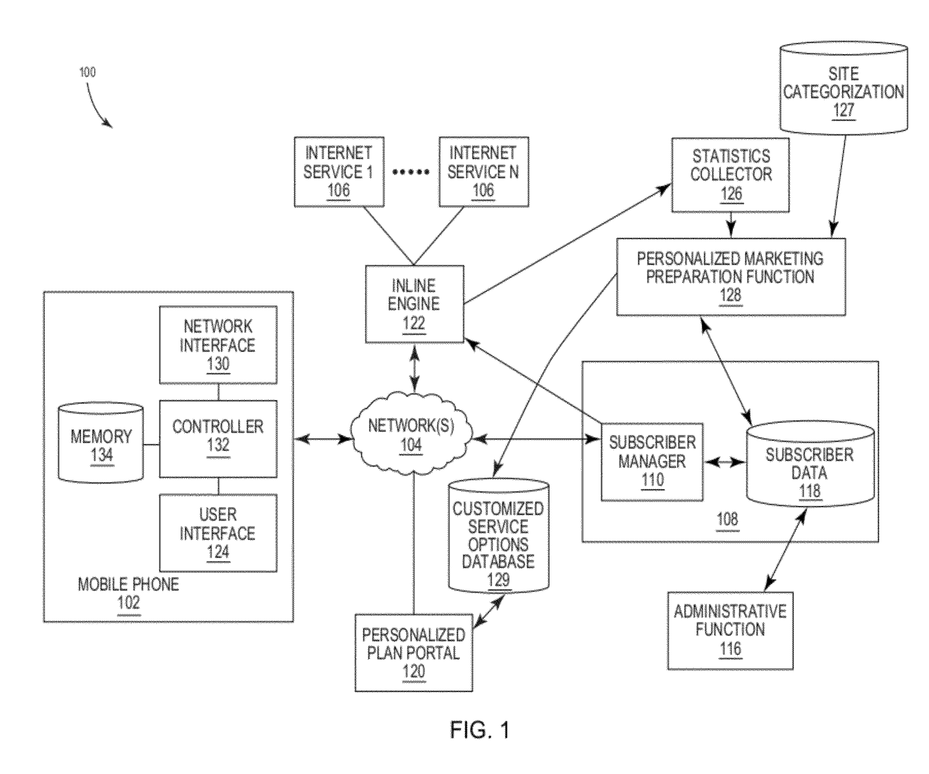

FIG. 1 illustrates a network diagram of an example system 100 for enabling personalization of a data service plan in accordance with embodiments of the present disclosure. Referring to FIG. 1, the system 100 includes a mobile phone 102 configured to communicate with one or more communications networks 104, such as the Internet, a wireless network, local area network (LAN), and/or any other suitable network. In this example, the mobile phone 102 is Internet-accessible and capable of interaction with one or more Internet services 106, phone services, or other services. Although the mobile phone 102 is used in this example, it should be understood that this component may instead be any other type of user equipment.

A user of the mobile phone 102 may be a subscriber having a subscription to Internet services provided by a service provider. The subscriber may use the mobile phone 102 and other devices for accessing the Internet services 106 and/or other network services provided by the service provider. The services and costs of the subscription may be set forth in a data service plan agreed upon between the subscriber and the service provider. This plan may be altered or a new plan provided to the subscriber in accordance with the presently disclosed subject matter.

A network server 108 may be configured to communicate with the network(s) 104 and to manage an Internet data service plan for the mobile phone 102. The server 108 and any of the other servers may be managed and operated by the service provider to the mobile phone 102. The server 108 may include a subscriber manager 110 and a subscriber data 118 configured to manage the Internet data service plan of the subscriber. In alternative embodiments, subscriber manager 110 and subscriber data 118 may reside on different servers, or their designated functions may be distributed across multiple servers. For implementing functions described herein, the subscriber manager 110 and subscriber data 118 may include one or more processors configured to operate with a memory; subscriber data 118, moreover, may include persistent storage for subscription-related data. In another example, the subscriber manager 110 and subscriber data 118 may be implemented by software, hardware, firmware, or combinations thereof. For example, the subscriber manager 110, subscriber data 118, and one or more other components of the system 100 may function together for enabling personalization of a data service plan, such as the Internet data service plan of the mobile phone 102. More particularly, for example, the subscriber manager 110, alone or in combination with one or more other components of the system 100, may receive profile and network usage data of a subscriber, such as the mobile phone 102, and may automatically generate a personalized data service offer for the subscriber based on the profile and network usage data. Further, the subscriber manager 110, alone or in combination with one or more other components of the system 100, may be configured to present the personalized data service offer to the subscriber in response to generating the personalized data service offer. For example, the subscriber manager 110, alone or in combination with one or more other components of the system 100, may communicate the personalized data service offer to the mobile phone 102, where the offer may be presented to the subscriber. As disclosed in further detail herein, the subscriber may interact with the mobile phone 102 for accepting the offer, after which the offered plan may be implemented by the service provider.

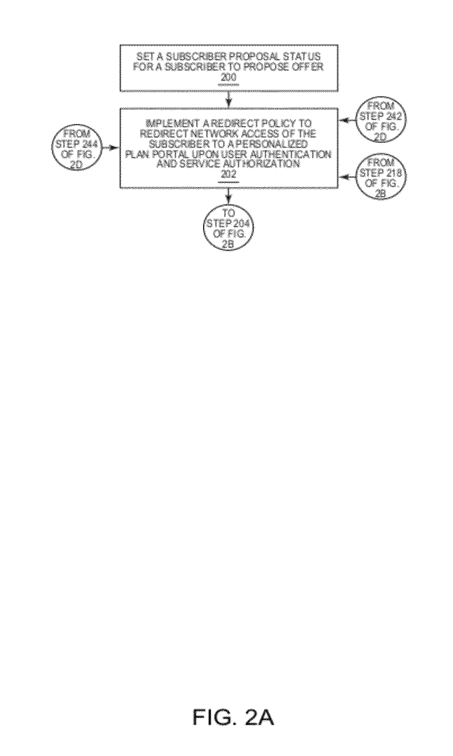

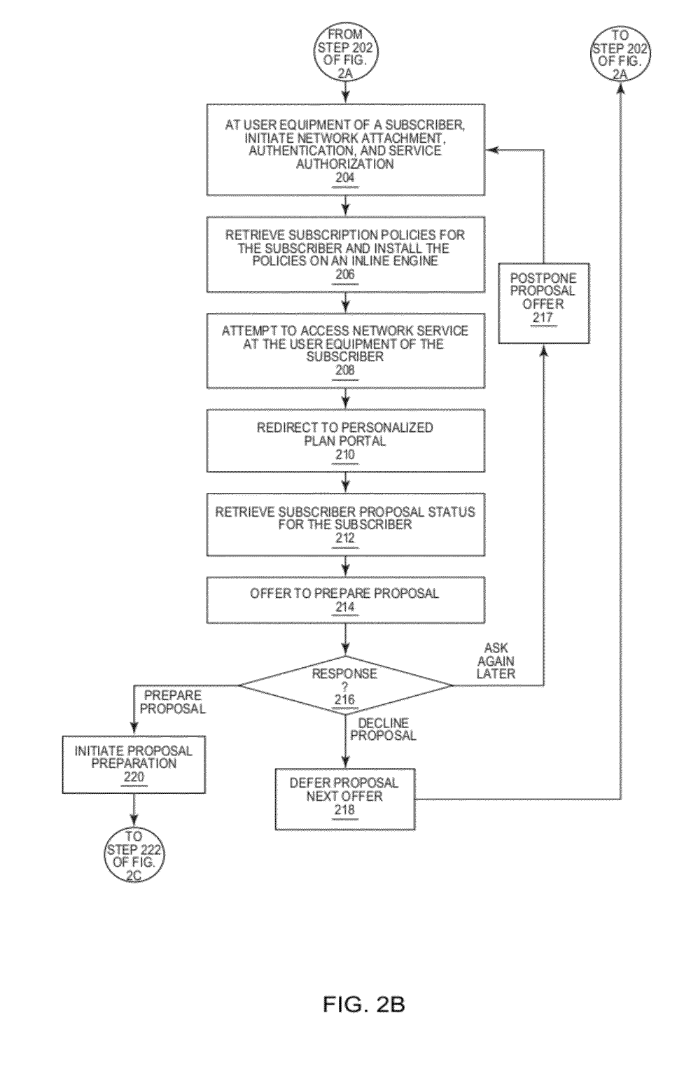

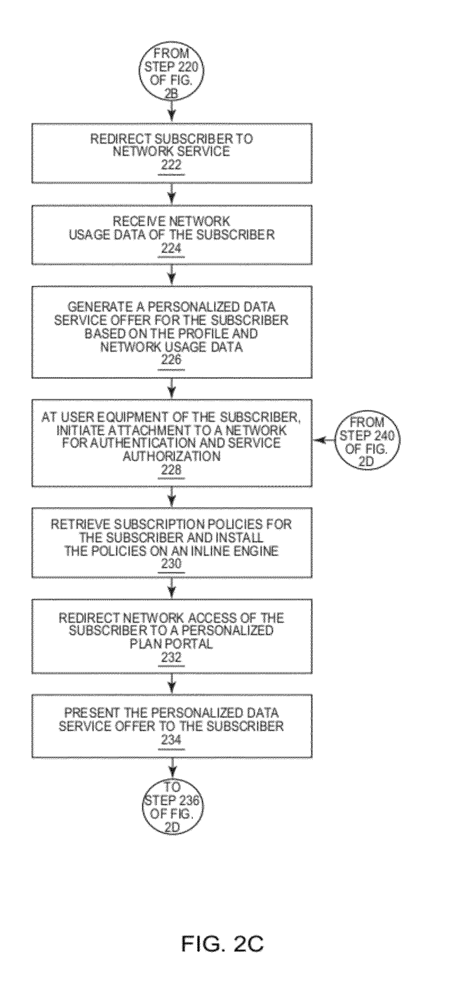

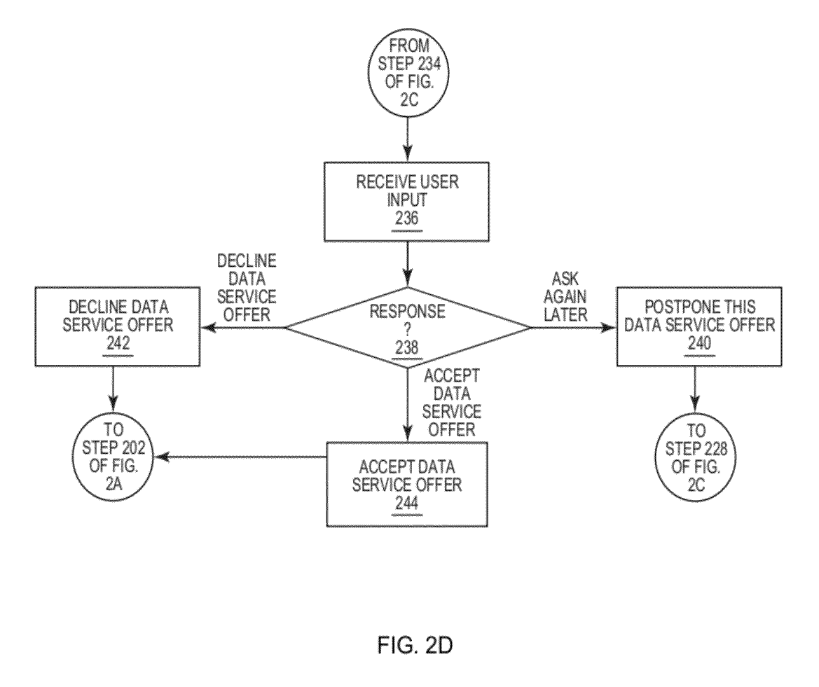

The operation of the system 100 for enabling personalization of a data service plan can be described by the example of FIGS. 2A, 2B, 2C, and 2D, which illustrates a flow chart of an example method for enabling personalization of a data service plan in accordance with embodiments of the present disclosure. The method of FIGS. 2A, 2B, 2C, and 2D is described with respect to the example system 100 shown in FIG. 1, although the method may be implemented by any suitable system. Further, for example, each of the steps of FIGS. 2A, 2B, 2C, and 2D may be implemented by software, hardware, firmware, or combinations thereof residing on one or more servers, user equipment, and/or other network components. It is also noted that this example method is specifically applied to mobile user equipment; however, it may also be suitably applied to any other type of user equipment in any other type of network environment, such as the user equipment accessing the network via cable or fixed broadband techniques.

Referring to FIGS. 2A, 2B, 2C, and 2D, the method includes setting a subscriber proposal status for a subscriber to “propose offer” (step 200). In other words, a status for the subscriber is set to enable the system 100 to initiate proposal of a personalized data service offer to the subscriber. In an example, an administrative function 116 (e.g., operator or service provider's customer care and/or operations support system (OSS) and/or billing support system (BSS)) may set the subscriber proposal status to either “propose offer” or “do not propose offer.” The status of “propose offer” indicates that a personalized data service offer for the subscriber is to be generated and provided to the subscriber. Conversely, the status of “do not propose offer” indicates that a personalized data service offer for the subscriber is not to be generated. Groups of subscribers may be targeted for a proposal offer based on their service plan, customer profile, and/or known privacy preferences. The subscriber proposal status may be stored within a subscriber data 118 storage area within server 108. The administrative function 116 may reside within a server, such as the server 108, and may be implemented by software, hardware, firmware, or combinations thereof. In an alternative example, the administrative function 116 may be reside on one or more servers or network devices capable of communicating subscriber proposal status information to a subscriber data 118. The subscriber proposal status may be set initially for all subscribers, and thereafter whenever service options are changed, for new subscribers, or for subscribers who request a personalized data service plan proposal.

The method of FIGS. 2A, 2B, 2C, and 2D includes implementing a redirect policy to redirect network access of the subscriber to a personalized plan portal upon user authentication and service authorization (step 202). For example, in response to the proposal status being set to “propose offer”, the subscriber data 118 may save in its storage of the user's subscription policies a redirect policy for redirecting network access of the subscriber to a personalized plan portal 120. The personalized plan portal 120 is represented as a function block in FIG. 1, although the functions of the personalized plan portal 120 may be implemented by one or more network components of the system 100, such as a server in communication with the network(s) 104. The redirect policy is, in the below described embodiment of this example method, assumed to apply to just the first Internet access attempted by the user in a data session; however, alternative embodiments may have the redirect policy apply to all Internet accesses, in which case the below described example method would require removal and addition of the redirect policy from and to the user's subscription policies at steps that should be understood to one skilled in the art.

The method of FIGS. 2A, 2B, 2C, and 2D includes initiating network attachment, authentication, and service authorization at user equipment of the subscriber (step 204). For example, the mobile phone 102 of a subscriber may initiate attachment to the network(s) 104, and undergo authentication and service authorization. The mobile phone 102 may initiate network attachment, authentication, and service authorization by suitably signaling to the network(s) 104. In another example, alternative to being from a mobile phone, the signaling may originate from any user equipment suitable for signaling of relevance (e.g., point-to-point protocol (PPP)). The network(s) 104 may terminate the signaling from mobile phone 102 and interact on behalf of the user with subscriber data 118, in order to authenticate the user, authorize data service for the user, and/or configure the mobile phone 102 and/or network(s) 104 for data service. Subscriber data 118 may be, for example, a standards-conformant policy server such as a 3GPP policy and charging rules function (PCRF), an AAA server, a home subscriber server (HSS), a server having a user profile server function (UPSF), a dynamic host configuration protocol (DHCP) server, and the like.

The signaling exchanged with subscriber data 118 may provide subscriber awareness, in the sense that the IP address of mobile phone 102 may be associated with an identity that is unique to the user (e.g., IMSI, MSISDN, and the like). This signaling providing user awareness may include, but is not limited to, RADIUS signaling to an authentication, authorization, and accounting (AAA) server, Diameter signaling to an HSS or UPSF, DHCP signaling to a DHCP server, GPRS tunneling protocol (GTP)-C or policy and charging control (PCC) Diameter signaling in 3GPP networks, and the like. An inline engine 122 having visibility to network traffic and relevant signaling associated with the mobile phone 102 may replicate relevant signaling and convey copies of signaling packets to the subscriber manager 110. In another example, the inline engine 122 may include the functionality of the subscriber manager 110 and may associate a user identity with the user's leased IP address via inspection of signaling (e.g., DHCP, RADIUS, GTP-C, lu-PS, Diameter, and the like). In yet another alternative example, the relevant signaling may be routed such that the inline engine 122 has no visibility to it. Regardless, the subscriber manager 110 may terminate or tap into this signaling providing user awareness (e.g., this process may be implemented in step 206 described below), enabling it to retrieve policies related to the user, such as the redirect policies described in step 202.

The method of FIGS. 2A, 2B, 2C, and 2D includes retrieving subscription policies for the subscriber and installing the policies on an inline engine (step 206) for enforcement. For example, in response to signaling providing user awareness, the subscriber manager 110 within server 108 may retrieve a redirect policy from subscriber data 118 and install the policy on an inline engine 122 having visibility to network traffic associated with the mobile phone 102. The inline engine 122 may be a deep packet inspection (DPI) inline engine or any suitable network node that integrates DPI functions, such as, but not limited to, an access gateway (e.g., gateway GPRS support node (GGSN), home agent, packet data network (PDN) gateway, and the like). In an embodiment of the method wherein the user equipment has fixed broadband or cable access, a suitable network node that integrates DPI functions could one or more of a broadband remote access server (BRAS), a broadband network gateway (BNG), a cable modem termination system (CMTS), and the like. The installed redirect policy may provide the inline engine 122 with visibility to a user identity associated with a permanent or leased IP address (e.g., a user name used in authentication or accounting records, IMSI, MSISDN, and the like).

The method of FIGS. 2A, 2B, 2C, and 2D includes attempting to access network service at the user equipment of the subscriber (step 208). For example, the user of the mobile phone 102 shown in FIG. 1 may interact with a user interface 124 of the mobile phone 102 for attempting access to Internet service 1 106 via the network(s) 104.

The method of FIGS. 2A, 2B, 2C, and 2D includes redirecting the user equipment to the personalized plan portal 120 in response to the first attempt of a data session to access network service (step 210). For example, the inline engine 122 may intercept user data from the mobile phone 102 for attempting to access the Internet service 1 106. The inline engine 122 may recognize the source IP address associated with the mobile phone 102 and, in response to such association with the stored policy for the subscriber, may redirect the mobile phone 102 to the personalized plan portal 120 in accordance with the redirect policy installed on the inline engine 122. In an alternative example, the subscriber may be directed to the personalized plan portal 120 by accessing a URL, such as a URL included in an emailed billing statement, in an SMS message, and the like.

The method of FIGS. 2A, 2B, 2C, and 2D includes retrieving the subscriber proposal status for the subscriber (step 212). For example, the personalized plan portal 120 may retrieve subscriber proposal status for the redirected subscriber from subscriber data 118 stored at the server 108. The subscriber proposal status may be retrieved by lookup based on a received source IP address or user identity of the subscriber that was either conveyed with redirected traffic or derived from the received source IP address. The retrieved subscriber status may indicate that the status is set to “propose offer” for the subscriber. In response to determining that the status is set to “propose offer,” the personalized plan portal 120 will initiate preparation of presentation of an offer proposal for the subscriber.

In the example of FIGS. 2A, 2B, 2C, and 2D, the subscriber proposal status is set to “propose offer”; thus, subsequent to retrieving the subscriber proposal status of “propose offer,” the method includes offering to prepare a data service plan proposal to the subscriber (step 214). For example, the personalized plan portal 120 may generate an interface suitable for presentation of an offer of a personalized service plan proposal to the subscriber at the mobile phone 102. In another example, the personalized plan portal 120 may generate a web page or another electronic document including text and/or graphics that offers to prepare a personalized data service plan proposal for the subscriber's review. In this example, the personalized plan portal 120 may communicate the web page to the mobile phone 102. The interface presented to the subscriber may include user-controllable functions for allowing the subscriber to limit the sort of personalized service plan proposals in which the subscriber may have interest. For example, the aforementioned web page may include a series of display screens used to filter the personalized service plan(s) in which the subscriber may have interest. Such display screens may be presented to the subscriber in response to the subscriber requesting preparation of a proposal.

The method includes determining a subscriber response to the offer to prepare a proposal (step 216). Continuing the aforementioned example of presenting the web page to the subscriber, the web page may include user-selectable responses to the offer including, but not limited to, a “Decline Proposal” (or “No thanks”) response, a “Present Proposal Later” (or “Ask me again later”) response, and an “Accept Proposal” (or “Prepare a proposal for me”) response. The web page may include display icons (e.g., user-selectable buttons) with which the subscriber may interact by use of the user interface 124 for selecting a desired response. By selection of the “Decline Proposal” (or “No thanks”) response, the subscriber indicates that he or she is not interested in receiving a proposal. By selection of the “Present Proposal Later” (or “Ask me again later”) response, the subscriber indicates that he or she is not presently interested in receiving a proposal but may be interested at a later time. By selection of the “Accept Proposal” (or “Prepare a proposal for me”) response, the subscriber indicates that he or she desires to receive a proposal. In response to user selection of a response, the mobile phone 102 may generate a message including the response, and may suitably communicate the message to the personalized plan portal 120. The personalized plan portal 120 may determine a subscriber response to the offer based on content of the message. Further, for example, the personalized plan portal 120 may determine a subscriber response based on expiration of a timer set when the offer was communicated to the mobile phone 102 and during which no response was provided by the subscriber.

In response to receipt of a “Decline Proposal” (or “No thanks”) response, the method may include deferring the next proposal offer (step 218) until a later time. For example, the next proposal offer may be deferred by a possibly provisioned, predefined amount of time. Also, for example, the personalized plan portal 120 may transition the subscriber proposal status in subscriber data 118 to a “defer next offer proposal” under which the next proposal offer is deferred for the predefined amount of time. In addition, for example, the aforementioned redirection policy may be deleted from the user's subscription policies at subscriber data 118, and subscriber data 118 may propagate this policy change to inline engine 122, possibly via subscriber manager 110. Personalized plan portal 120 may further redirect the user to Internet service 1 106, as the user originally requested, and thereafter the user's data service may continue per his or her subscribed plan until which time the predefined amount of time has elapsed, subscriber data 118 transitions proposal status to a “propose offer” state, and the method returns to step 202.

In response to receipt of a “Present Proposal Later” (or “Ask me again later”) response, the method of FIGS. 2A, 2B, 2C, and 2D may return to step 204. In an example, and represented by Step 217, personalized plan portal 120 may leave untouched the subscriber proposal status in subscriber data 118, and may further redirect the user to Internet service 1 106, as the user originally requested. Thereafter the user's data service may continue per his or her subscribed plan, until the user initiates another data session and/or a predefined or provisioned amount of time has elapsed, at which point the method continues at step 204.

In response to receipt of “Accept Proposal” (or “Prepare a proposal for me”) response, data service proposal preparation may be initiated for the subscriber (step 220). For example, in response to receipt of a message indicating a request to prepare a proposal from the mobile phone 102, the personalized plan portal 120 may change the subscriber proposal status at subscriber data 118 from “propose offer” to “offer preparation.” Personalized plan portal 120 may further include one or more statistics-collection policies in the user's subscription policies in subscriber data 118, if inline engine 122 requires such policies to collect user-specific traffic statistics. Further, the aforementioned redirection policy may be deleted from the user's subscription policies at subscriber data 118. Finally, subscriber data 118 may propagate subscription policy changes to inline engine 122 and the method continues at step 222. Changes may be propagated via the subscriber manager 110.

At step 222, the method of FIGS. 2A, 2B, 2C, and 2D includes redirecting the subscriber to the network service. For example, the mobile phone 102 may be redirected by the personalized plan portal 120 to the Internet service 1 106 or any other network service originally requested by the subscriber. The mobile phone 102 may then have access to the services provided by the Internet service 1 106, such as VoIP or website access.

It is noted that the aforementioned description of FIGS. 2A, 2B, 2C, and 2D discloses example steps by which a subscriber may opt in to receiving a proposal for a personalized data service plan. In areas where opting in is not required and where the service provider or operator deems opting to be unnecessary, the aforementioned example steps may be skipped or omitted in the example method by having the administrative function 116 interact with the subscriber data 118 by, for example, setting the proposal status to “offer preparation” state within the subscriber data 118, and initializing statistics collection policies if required by the inline engine 122. Where such statistics collection policies are necessary, subscriber data 118 may push these to the subscriber manager 110 for installation and enforcement on the inline engine 122.

The method of FIGS. 2A, 2B, 2C, and 2D includes receiving network usage data of the subscriber (step 224). For example, the inline engine 122 shown in FIG. 1 may be configured to store network usage data to a statistics collector 126, which may be a functional part of the inline engine 122 or a function residing within another server or network component in communication with the inline engine 122. The network usage data may include, for example, but be not limited to, user-tagged traffic statistics saved by the inline engine 122. The inline engine 122 collects traffic statistics for the user over a provisioned period of time, provisioned number of subscriber sessions, provisioned amount of data transferred (e.g., number of megabytes of data), provisioned number of service invocations or content accesses, the like, and combinations thereof. Such network usage data may be collected or determined based on an interaction by the mobile phone 102 and/or another device of the subscriber with one or more network services (e.g., Internet service 1 106 to Internet service N 106). Network usage data may include various statistics such as, but not limited to, identification of applications and services used and content accessed, frequency of such usage and access, traffic volumes and bandwidth associated with the same, and the like.

Subscriber profile and network usage data may include a variety of information collected about the subscriber's preferences for service, current service plan, and various data about the usage of one or more networks by one or more user equipment of the subscriber. For example, network usage data may include historical network usage of a subscriber, statistical network usage data of the subscriber, the like, and combinations thereof. Further, for example, subscriber profile data may include current data subscription information of the user, including any changes that may have been incorporated as a result of the user's interaction with customer service or by acceptance of a data service that was proposed by this example method.

The method of FIGS. 2A, 2B, 2C, and 2D includes generating a personalized data service offer for the subscriber based on the user's profile and network usage data (step 226). For example, a personalized marketing preparation function 128 may periodically check subscriber traffic statistics data stored at the statistics collector 126 and/or stored subscriber data 118 of server 108 to determine which subscribers with a positive offer preparation status have met predefined or provisioned criteria for preparing an offer. Such criteria are intended to ensure that sufficient statistics have been collected to accurately exemplify how a user interacts with IP-accessed services. For a subscriber having met the predefined criteria for preparing an offer, the personalized marketing preparation function 128 may utilize user-tagged statistics to prepare a traffic profile per subscription or per user for multi-user subscriptions. Based on the current subscription information, traffic profile(s), BSS interaction (if applicable), and offerings that the service provider is ready to support, the personalized marketing preparation function 128 may automatically generate or assemble one or more data service offers. A site categorization database 127 may be consulted for offerings involving content filtering (e.g., parental controls). Further, the personalized marketing preparation function 128 may write the data service offer(s) to a customized service options database 129, and transition the subscriber's proposal status within subscriber data 118 to “offer ready” for indicating that one or more data service offers are available for subscriber review. In conjunction with this status transition to “offer ready,” any related statistics-collection policies may be removed from subscription policies in subscriber data 118, and a policy may be added to subscription policies in subscriber data 118 to redirect the subscriber to the personalized plan portal 120 after authentication and service authorization. The personalized marketing preparation function 128 may be a functional part of the server 108 or a function residing within another server or network component in communication with the statistics collector 126 and the server 108. For a presently active subscriber, subscriber data 118 may subsequently push appropriate policy modifications to the subscriber manager 110 with resulting policy changes on the inline engine 122.

The method of FIGS. 2A, 2B, 2C, and 2D includes initiating, at user equipment of the subscriber, attachment to a network for authentication and service authorization (step 228). For example, the subscriber's mobile phone 102 or other user equipment of the subscriber may signal to the network(s) 104 for initiating attachment and for undergoing authentication and service authorization, as described previously for step 204.

The method of FIGS. 2A, 2B, 2C, and 2D includes retrieving subscription policies for the subscriber and installing relevant policies on an inline engine 122 for enforcement (step 230), as described previously for step 206. For example, the subscriber manager 110 may control the tapping into or processing of the signaling providing user awareness, retrieve subscription policies from the subscriber data 118 based on the user's identity, and install the subscription polices on the inline engine 102 for enforcement. In an example, the subscriber manager 110 may provide the inline engine 122 with visibility to the user identity associated with the leased IP address of the subscriber. In another example, the inline engine 122 may associate a user identity with the subscriber's leased IP address via inspection of signaling (e.g., DHCP, RADIUS, GTP-C, lu-PS, Diameter, and the like).

The method of FIGS. 2A, 2B, 2C, and 2D includes redirecting network access of the subscriber to a personalized plan portal (step 232), as described previously for steps 208 and 210. Continuing the aforementioned example, the mobile phone 102 may attempt access to the Internet service 1 106. In response to the access attempt, the inline engine 122 may redirect the mobile phone 102 to the personalized plan portal 120 in accordance with the policies installed on the inline engine 122.

The method of FIGS. 2A, 2B, 2C, and 2D includes presenting the personalized data service offer to the subscriber (step 234). For example, in response to redirection of the user's attempt to access the Internet service 1 106, the personalized plan portal 120 may employ the user's source IP address or received user identity to retrieve proposal status from the subscriber data 118. Given proposal status of “offer ready,” indicating that the offer is available for subscriber review, the portal 120 may retrieve the personalized data service offer from customized service options 129 and may present the offer to the subscriber. More particularly, for example, the personalized plan portal 120 may send the offer to the mobile phone 102. The portal 120 may send one or more offers to the mobile phone 102. The mobile phone 124 may present the offer to the subscriber via the user interface 124. For example, the offer may be presented to the subscriber via a display of the user interface 124. The mobile phone 102 can be Internet-accessible and can interact with the server 104 using Internet protocols such as HTTP, HTTPS, and the like via the network interface 130. Further, the mobile phone 102 may include a controller 132 and memory 134 for implementing functionality as described herein and for communicating with the network(s) 104. The controller 132 may suitably control the user interface 124 for displaying information and graphics, and for receiving user input in accordance with the presently disclosed subject matter.

The method of FIGS. 2A, 2B, 2C, and 2D includes receiving user input (step 236). For example, the subscriber may interact with the user interface 124 of the mobile phone 102 for interacting with the offer presentation. The mobile phone 102 may use a network interface 130 for communicating the user input to the personalized plan portal 120. The portal 120 may then receive the user input.

The method of FIGS. 2A, 2B, 2C, and 2D includes determining, at the personalized plan portal 120, the subscriber's response to the data service(s) offer (step 238). For example, the user may have postponed making a decision on the offer—“present offer later” (or “ask me again later”)—accepted one or more offered data services, or rejected the data service(s) offered in toto. The portal 120 may also infer a subscriber response, such as “present offer later,” in the absence of response, based on expiry of a timer set when the offer was communicated to the mobile phone 102.

In response to receipt of a “Present Offer Later” (or “Ask Me Again Later”) response, the method of FIGS. 2A, 2B, 2C, and 2D may continue by enabling postponement of a decision on the data service(s) offer in step 240. For example, personalized plan portal 120 may enable postponement by leaving untouched the subscriber proposal status in subscriber data 118, and by redirecting the user to Internet service 1 106, to which the user was seeking access prior to redirection to portal 120. Thereafter, the user's data service may continue per his or her subscribed plan until which time the user initiates another data session and/or a predefined or provisioned amount of time has elapsed, at which time the method continues at step 228.

In response to the user rejecting the data service(s) offered in entirety—a “Decline Offer” (or “No Thanks”) response—the method of FIGS. 2A, 2B, 2C, and 2D may continue from step 238 by discarding the personalized data service(s) offer developed for the subscriber and effectively scheduling the next proposal to prepare an offer in step 242. For example, personalized plan portal 120 may interact with customized service options 129 to delete from its storage the data service(s) offer that was prepared for the user. The portal 120 may further, for example, transition the user's proposal status in subscriber data 118 to a “defer next offer proposal” state under which the next proposal to prepare a personalized data service(s) offer is deferred by a provisioned or predefined amount of time. In addition, for example, the aforementioned redirection policy may be deleted from the user's subscription policies at subscriber data 118, and subscriber data 118 may propagate this policy change to inline engine 122. For example, the policy change may be propagated via subscriber manager 110. Further, by way of example, portal 120 may redirect the user to Internet service 1 106, to which the user was seeking access prior to redirection to portal 120. Thereafter, for example, the user's data service may continue per his or her subscribed plan until which time the provisioned or predefined amount of time has elapsed, subscriber data 118 transitions proposal status to a “propose offer” state, and the method continues at step 202.

In response to the user accepting one or more offered data services—an “Accept Offer” (or “Confirm Your Upgrade Selection(s)”) response—the example method of FIGS. 2A, 2B, 2C, and 2D may continue from step 238 by putting into effect the selected data service(s) in the user's subscription (step 244). For example, personalized plan portal 120 may update subscriber data 118 with subscription changes related to the data service(s) offerings selected by the user, and transition the user's proposal status in subscriber data 118 to a “defer next offer proposal” state under which the next proposal to prepare a personalized data service(s) offer is deferred by a provisioned or predefined amount of time. Furthering this example, the personalized plan portal 120 may interact with customized service options 129 to delete from its storage the data service(s) offer that was prepared for the user. The portal 120 may additionally, for example, interact with the OSS or BSS to further provision the selected data service(s). In addition, for example, the aforementioned redirection policy may be deleted from the user's subscription policies at subscriber data 118, and subscriber data 118 may propagate this policy change, along with any other policy changes related to the selected data service(s), to inline engine 122, via subscriber manager 110 as an example. Finally, and again by way of example, portal 120 may redirect the user to Internet service 1 106, to which the user was seeking access prior to redirection to portal 120. Thereafter, for example, the user's data service may continue per his or her subscribed plan until which time the aforementioned, provisioned or predefined amount of time has elapsed, subscriber data 118 transitions proposal status to a “propose offer” state, and the method continues at step 202.

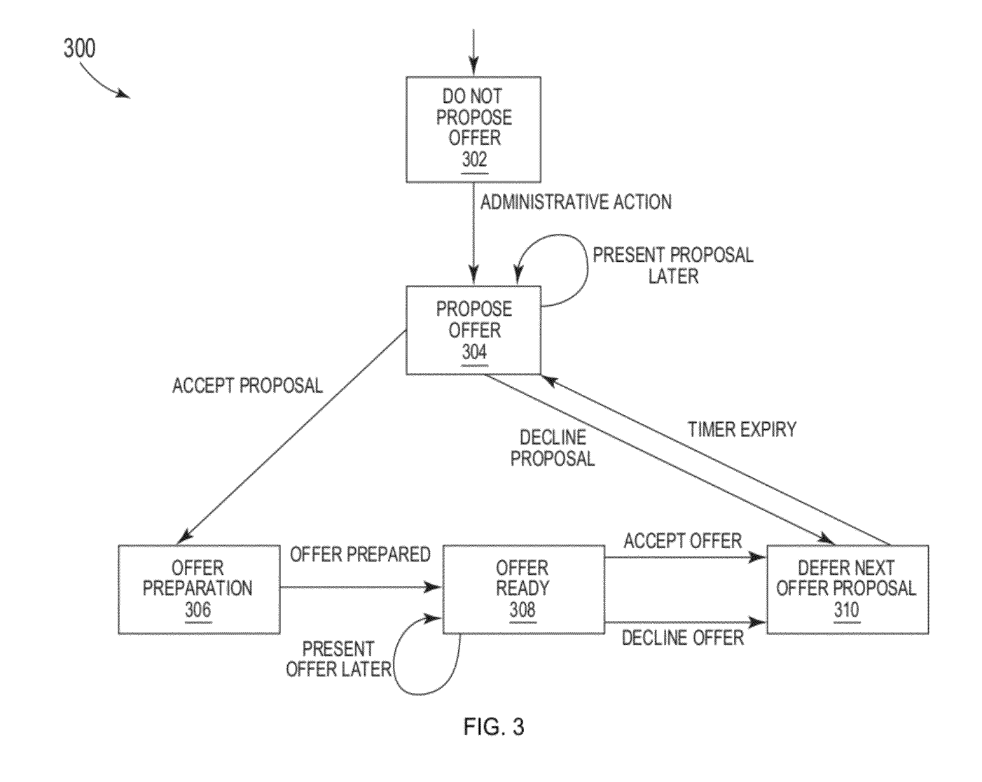

Referring to FIG. 3, an example finite state machine (FSM) 300 may be implemented by system 100, with state data maintained within subscriber data, such as subscriber data 118, and modified by subscriber data 118 and/or other component taking actions based upon state. Events causing state transitions, as implied by the labels on arrows, include user input, timer expiry, administrative action, and readiness of requested data service(s) offer for presentation to the user. While not depicted in FIG. 3, actions described by the method and taken by various elements of FIG. 1 are predicated by state transitions shown. While not shown for the most part, so as to simplify FIG. 3, all other states have a transition to the “Do Not Propose Offer” state that is triggered by administrative action. This may allow the operator's customer care service to respond to customer requests to preclude any further proposals to upgrade the customer's data service per the example method described herein. The actions for such state transitions vary, in a way that should be appreciated by those skilled in the art, in accordance with the state from which the transition occurs.

The FSM 300 may begin at a state 302 in which no offer is proposed to the subscriber. The FSM 300 may enter a state 304 for proposing an offer based upon any suitable administrative action disclosed herein. In the FSM 300, no state change occurs in response to the subscriber deferring a decision on the offer or proposal. A decision on the offer or proposal may be deferred by receipt of user input to “Ask again later,” in which case an offer or proposal may be presented later. If the user declines the offer or proposal at state 304 or 308 respectively, the next offer or proposal is respectively deferred by a provisioned or predefined amount of time at state 310, after which the FSM 300 returns to state 304. If the subscriber accepts a proposal to prepare an offer, the FSM 300 may transition to an offer preparation state 306 in which an offer is prepared. Next, the FSM 300 indicates that the data service(s) offer is ready at state 308. Subsequent to the subscriber either accepting the offer or declining the offer, the FSM 300 may transition to state 310 for the provisioned or predefined amount of time before transitioning to state 304. The FSM 300 may remain at state 308 in response to the subscriber deferring a decision on the data service(s) offer.

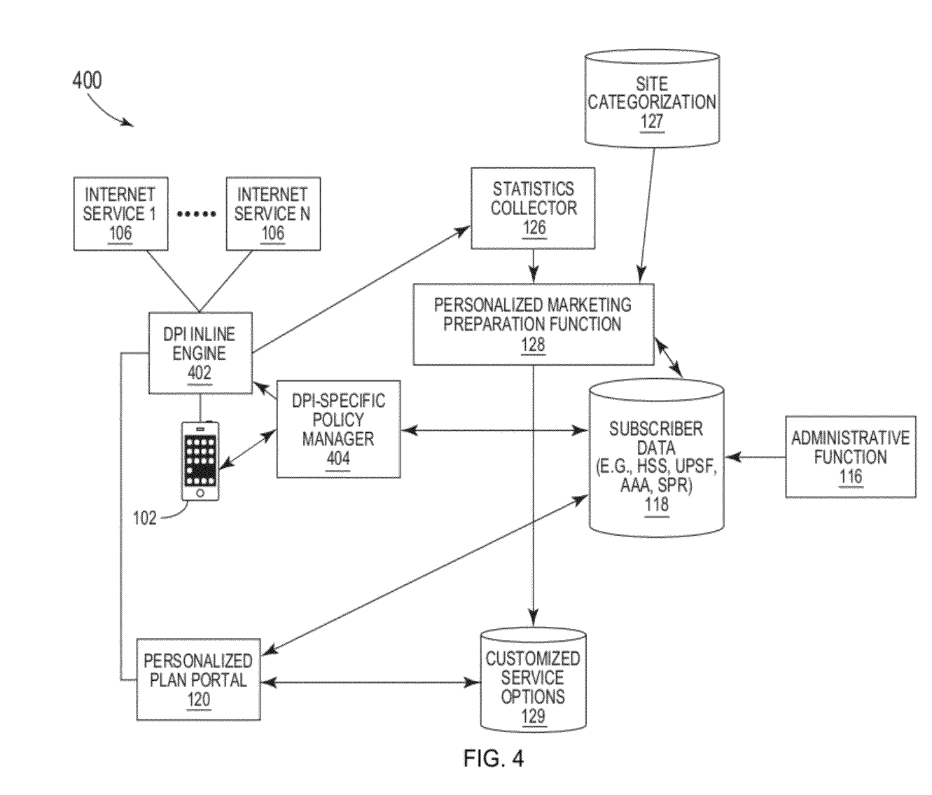

In accordance with embodiments of the present disclosure, FIG. 4 illustrates a network diagram of another example system 400 for enabling personalization of a data service plan. Some of the network components shown in FIG. 4 may include functionality implemented within one or more servers. Referring to FIG. 4, the system 400 includes a DPI inline engine 402 configured to implement the functions of the example inline engines disclosed herein, such as the inline engine 122 shown in FIG. 1. The DPI inline engine 402 may be a standalone network component, or may be integrated with an edge router, access-specific aggregation point (e.g., BRAS, BNG, CMTS, OLT, GGSN, PDN gateway, PDN gateway, HA, PDSN, ASN-GW, and the like), or other suitable network component.

In an embodiment, a DPI-specific policy manager 404 may be integrated with the DPI inline engine 402, or a standalone network component. If standalone, the manager 404 may front centralized network components such as, but not limited to, an AAA server, DHCP server, and the like. The manager 404 may provide subscriber-awareness for the DPI functions via signaling taps and pushing related policies to the inline engine 402. Signaling that supplies visibility to the subscriber may include, but is not limited to, RADIUS to an AAA server, Diameter to HSS or UPSF, DHCP to DHCP server, GTP-C in 3GPP networks, and the like. Further, the manager 404 may integrate a subscriber data repository and/or interface to an external repository or database, such as subscriber data 118.

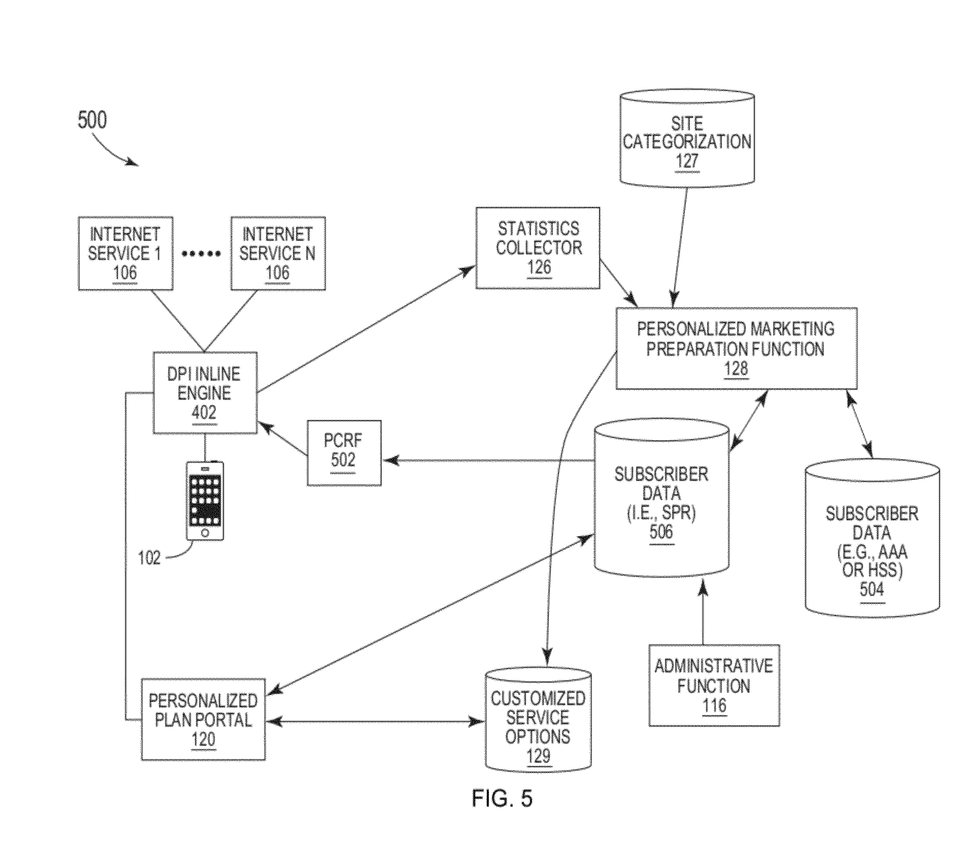

In accordance with embodiments of the present disclosure, FIG. 5 illustrates a network diagram of another example system 500 for enabling personalization of a data service plan. Some of the network components shown in FIG. 5 may include functionality implemented within one or more servers. Referring to FIG. 5, the DPI inline engine 402 is configured to terminate policy and charging rules function (PCRF) 502 signaling. This example uses standalone DPI and a 3GPP-conformant PCRF. The standalone DPI inline engine 402 can either directly terminate PCRF 502 signalling or be fronted by an intermediary node that maps PCRF 502 signaling to DPI-specific policies. This signalling from PCRF 502 could either be a subset of protocols exchanged over 3GPP policy and charging control (PCC) reference point Gx, or a (possibly augmented) set of PCC protocols exchanged over the Sd interface that is being specified by 3GPP Release 11. The PCRF 502 may be configured to be involved with authentication and service authorization via access gateway interactions, thereby associating user's identity and IP addresses and providing, via this association, user awareness to DPI inline engine 402.

Subscriber data may be stored in separate databases 504 and 506. For example, subscriber data may be stored in an AAA and/or HSS database 504. Further, for example, subscriber data may be stored in a PCRF-associated subscriber policy repository (SPR) 506.

Systems and methods in accordance with embodiments of the present disclosure can provide personalized data service plans. Further, for example, the systems and methods disclosed herein can provide improved monetization of a smart pipe for access service providers. Features include, but are not limited to: marketing user-adapted, personalized plans in an automated fashion; incorporating subscriber self-provisioning via a user-friendly interface; and automating related provisioning of network infrastructure and the OSS and BSS.

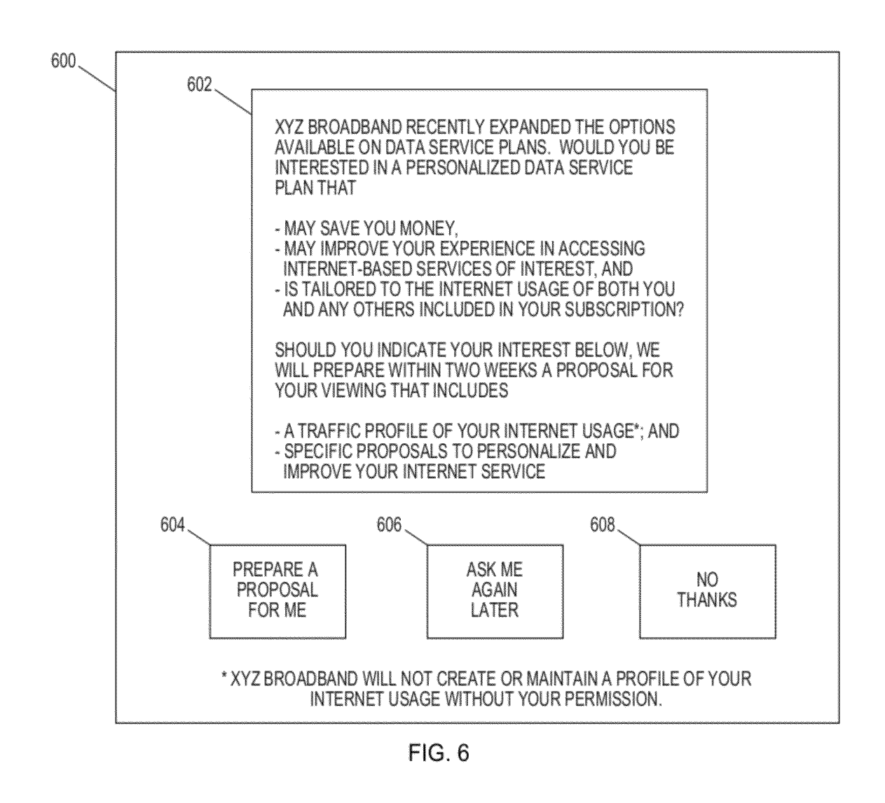

FIG. 6 illustrates a display screen 600 with which a subscriber may interact for opting into a personalized data service offer in accordance with embodiments of the present disclosure. In an example, the display screen 600 may be displayed to the subscriber by the user interface 124 of the mobile phone 102. Referring to FIG. 6, the display screen 600 may display a window 602 including text describing the benefits of a personalized data service plan. In addition, the display screen 600 includes multiple selection boxes 604, 606, and 608 with which the subscriber may interact for opting into receiving an offer, declining the proposal for the offer, and requesting that the proposal be provided at a later time. For example, the subscriber may suitably interact with the box 604 for requesting preparation of an offer. The subscriber may suitably interact with the box 606 for requesting that the proposal be presented at a later time. The subscriber may suitably interact with the box 608 for declining the proposal.

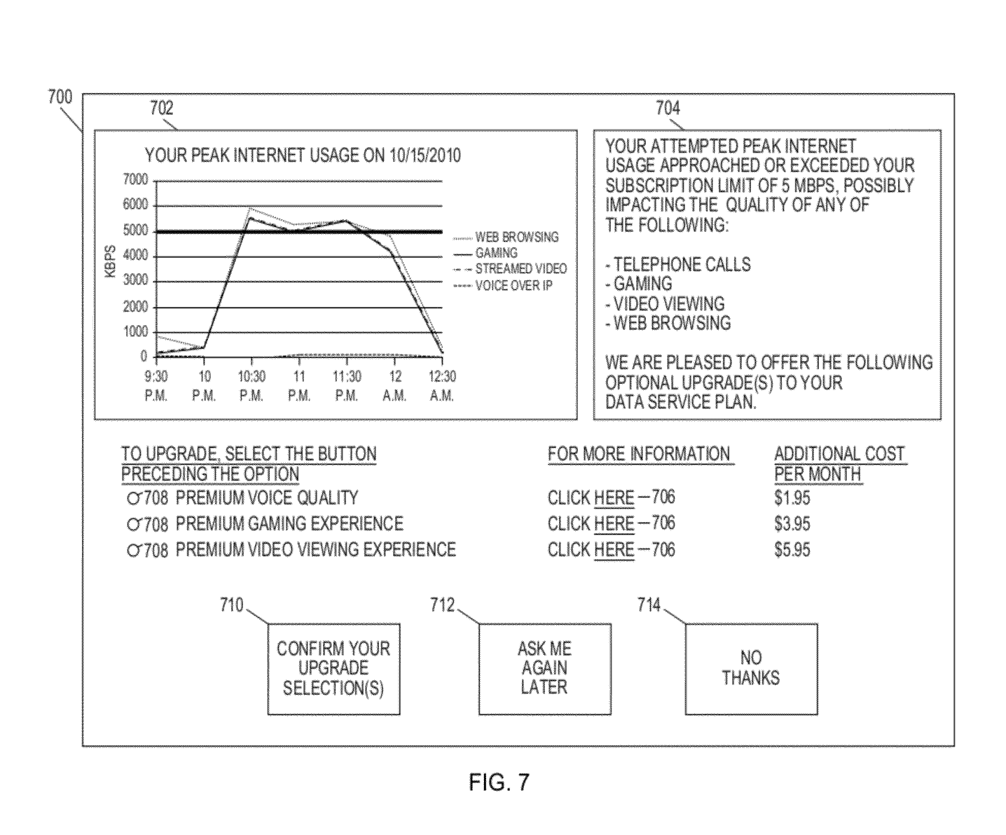

FIG. 7 illustrates a display screen 700 presenting a personalized data service offer defining multiple personalized data service plans in accordance with embodiments of the present disclosure. In an example, the display screen 700 may be displayed to the subscriber by the user interface 124 of the mobile phone 102. Referring to FIG. 7, the display screen 700 displays a window 702 including a graph showing the subscriber's Internet usage among various categories on a particular day. In addition, the display screen 700 displays a window 704 including text for informing the subscriber that his or her peak Internet usage approached or exceeded a subscription limit and for offering an upgrade to the subscriber's data service plan.

The multiple personalized data service plans are identified near the bottom of the display screen 700 and include a “Premium Voice Quality” plan for an additional charge of $1.95 per month. The plans also include a “Premium Gaming Experience” plan for an additional charge of $3.95 per month, and a “Premium Video Viewing Experience” plan for an additional charge of $5.95 per month. Additional information about each plan may be requested by selecting a corresponding hyperlink 706. A plan may be selected by suitably selecting a corresponding button 708. Subsequently, the selected plan may be confirmed by selecting a box 710. Further, the subscriber may request that the offer be presented at a later time by selecting a box 712. The subscriber may decline the offer by selecting a box 714.

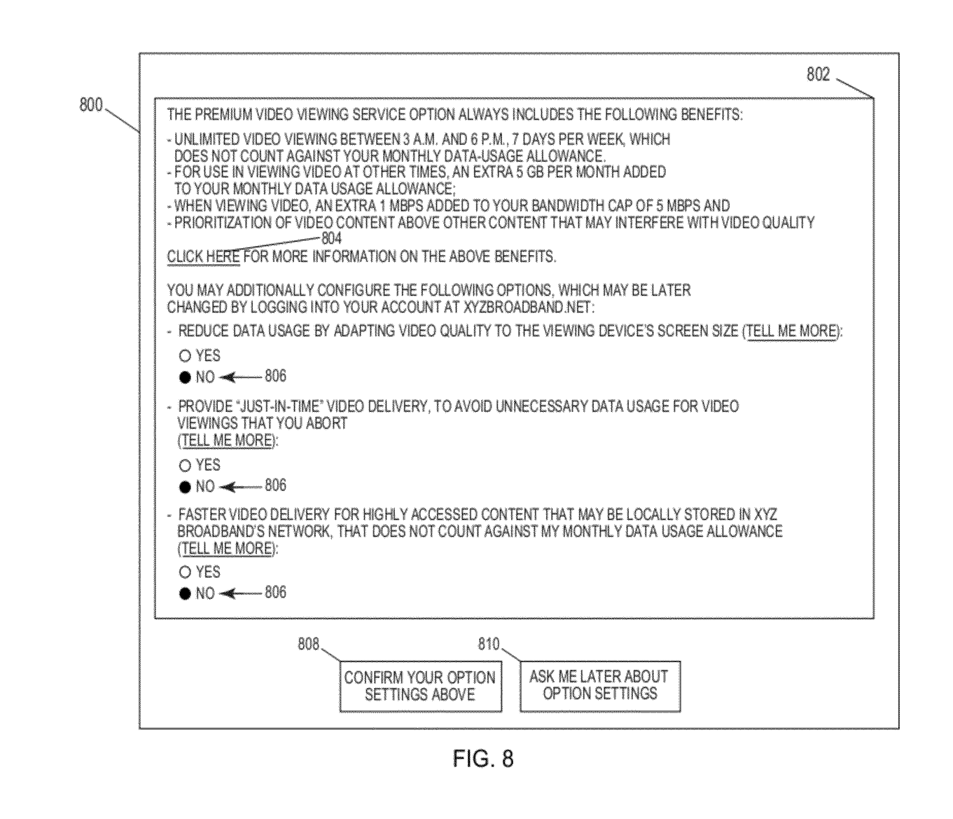

FIG. 8 illustrates a display screen 800 presenting information about a premium video viewing service option in accordance with embodiments of the present disclosure. In an example, the display screen 800 may be displayed to the subscriber by the user interface 124 of the mobile phone 102, after the user has requested additional information about this option by means of an aforementioned hyperlink 706. Referring to FIG. 8, the display screen 800 displays a window 802 including text describing terms of the premium video viewing service plan and a hyperlink 804 for more information. The display screen 800 also displays user-selectable icons 806 for configuring options of the plan. The subscriber may confirm the option settings by selecting a box 808. The subscriber may request that the options be presented at a later time by selecting a box 810. In this way, the subscriber may provide data service configuration information for use by, for example, the personalized plan portal 120 shown in FIG. 1 in configuring an offered data service.

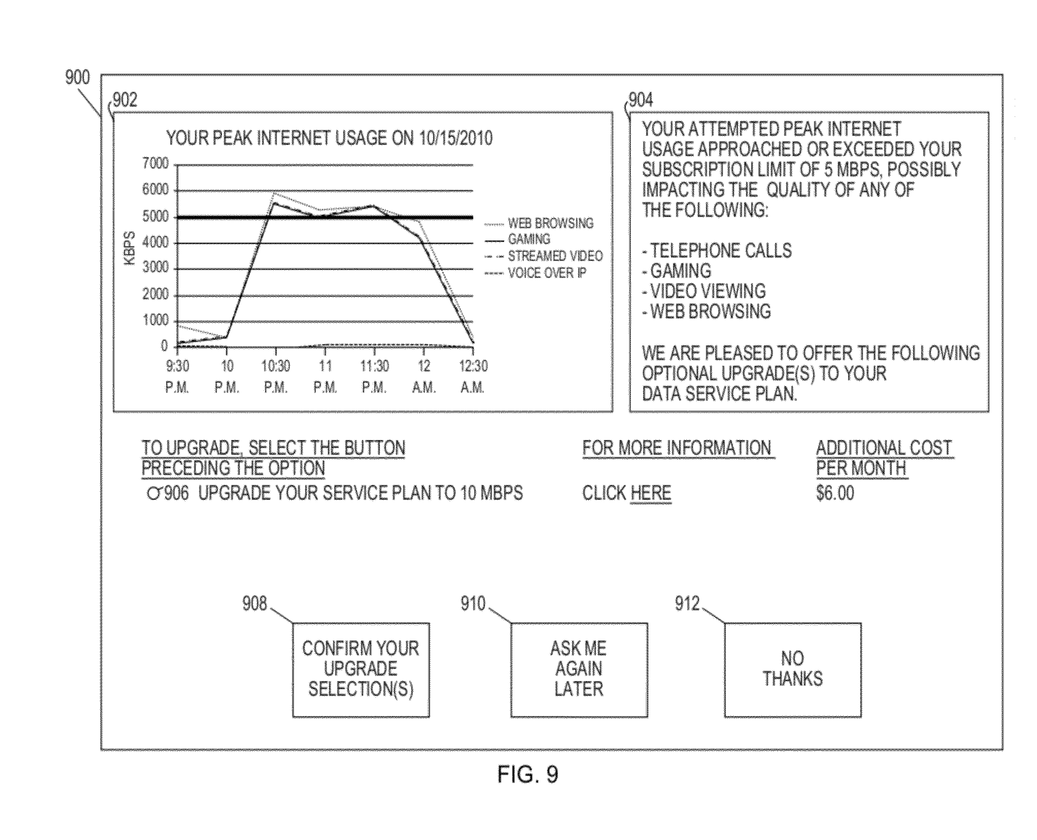

FIG. 9 illustrates a display screen 900 presenting information offering to upgrade a subscriber plan to another bandwidth tier in accordance with embodiments of the present disclosure. In an example, the display screen 900 may be displayed to the subscriber by the user interface 124 of the mobile phone 102. Referring to FIG. 9, the display screen 900 displays a window 902 including a graph showing the subscriber's Internet usage. The display screen 900 also includes a window 904 including text for informing the subscriber that his or her peak Internet usage approached or exceeded a subscription limit and that offers an upgrade to the subscriber's data service plan. The display screen 900 shows an offer to upgrade the bandwidth in the subscriber's data service plan at an additional cost of $6.00 per month. The plan offer may be selected by suitably selecting a button 906. Subsequently, the selected upgrade may be confirmed by selecting a box 908. Further, the subscriber may request that the upgrade offer be presented at a later time by selecting a box 910. The subscriber may decline the offer by selecting a box 912.

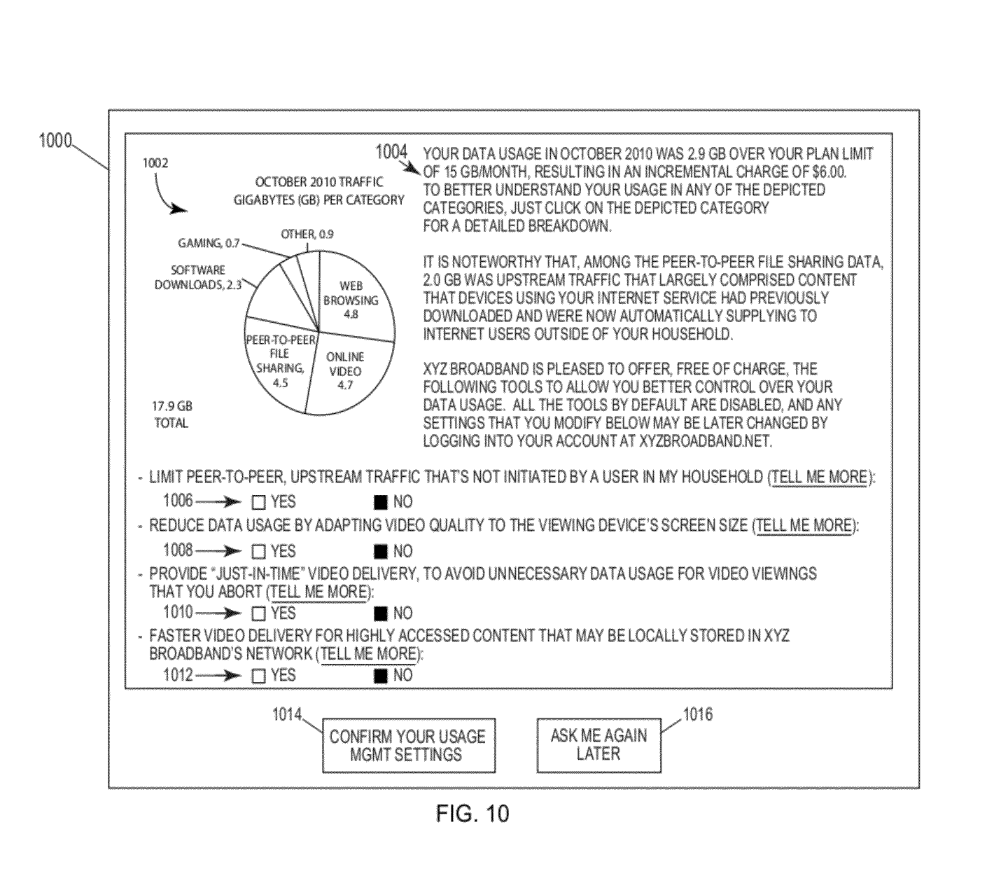

FIG. 10 illustrates a display screen 1000 offering usage-management controls for a tiered data usage plan in accordance with embodiments of the present disclosure. In an example, the display screen 1000 may be displayed to the subscriber by the user interface 124 of the mobile phone 102. Referring to FIG. 10, the display screen 1000 displays a pie chart 1002 showing a categorical distribution of data traffic for a subscriber in a particular month. The display screen 1000 also displays text 1004 describing the data usage over the subscriber's plan limit and tools available for controlling the subscriber's data usage. The subscriber may select various boxes 1006, 1008, 1010, and 1012 for controlling data usage. For example, the subscriber may limit peer-to-peer, upstream traffic that is not initiated by a user in his or her household. Peer-to-peer, downstream traffic may be similarly controlled. Further, for example, the subscriber may reduce data usage by adapting video quality to the viewing device's screen size. In another example, the subscriber may select to provide “just-in time” video delivery to avoid unnecessary data usage for a progressive video viewing that is aborted. In another example, the subscriber may select for faster video delivery for highly accessed content that is cached in the broadband provider's network. Usage management settings may be confirmed by selection of box 1014. Further, the subscriber may request that the control screen be presented at a later time by selecting a box 1016.

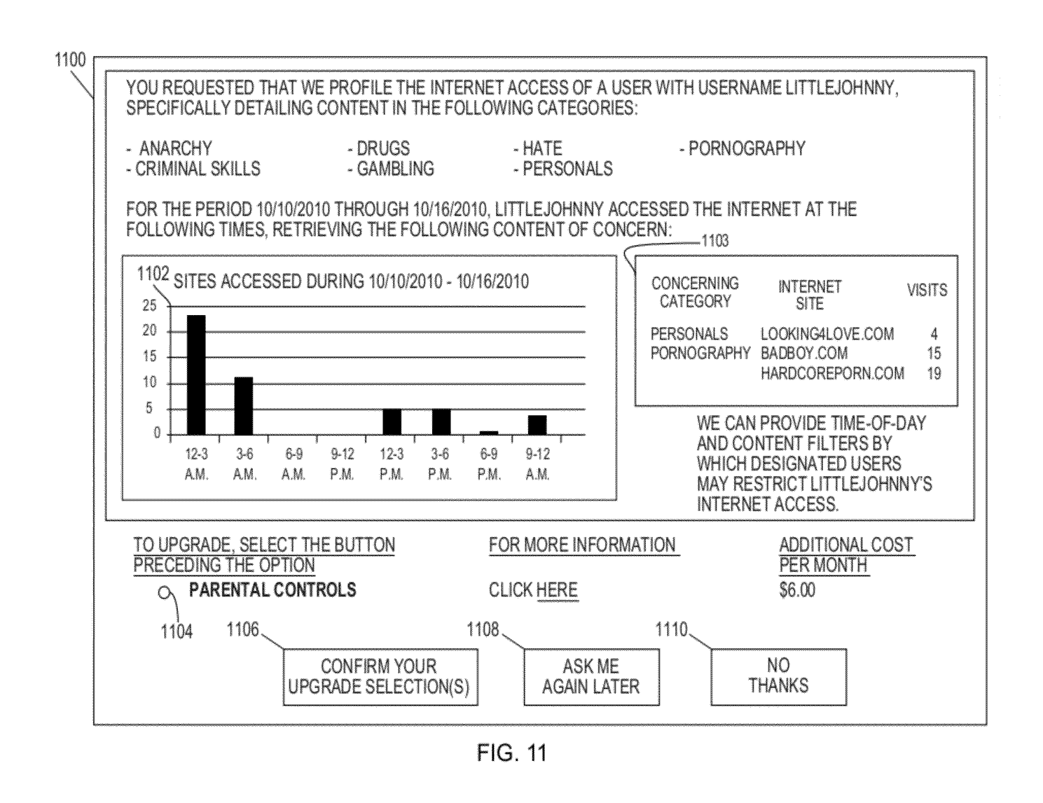

FIG. 11 illustrates a display screen 1100 presenting parental controls in accordance with embodiments of the present disclosure. In an example, the display screen 1100 may be displayed to the subscriber by the user interface 124 of the mobile phone 102. Referring to FIG. 11, the display screen 1100 displays a response to the subscriber's request to profile Internet access of a user with username “littlejohnny” in a variety of categories. Further, the display screen 1100 displays a chart 1102 indicating the numbers of unique sites accessed by the user during designated time periods in a specified week. The display screen 1100 also displays in box 1103 the URL of Internet sites associated with the categories specified by the subscriber. The subscriber may select to upgrade his or her plan by selecting a button 1104 for adding parental control features for content filtering, which may be defined based on web site accesses by the specified user. Subsequently, the selected upgrade may be confirmed by selecting a box 1106. Further, the subscriber may request that the upgrade offer be presented at a later time by selecting a box 1108. The subscriber may decline the offer by selecting a box 1110. In response to confirming selection of the parental control features, the content filtering service may be implemented for the subscriber.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method for enabling personalization of a data service plan, the method comprising:
receiving profile and network usage data of a subscriber;
automatically generating a personalized data service offer for the subscriber based on the profile and network usage data; and
automatically presenting the personalized data service offer to the subscriber.

2. The method of claim 1, further comprising storing the personalized data service offer for subsequent presentation to the subscriber.

3. The method of claim 1, wherein presenting the personalized data service offer comprises displaying the personalized data service offer to the subscriber.

4. The method of claim 1, wherein the profile and network usage data comprises one or more of historical network usage of the subscriber, statistical network usage data of the subscriber, and current subscription information of the subscriber.

5. The method of claim 1, wherein the personalized data service offer defines a plurality of personalized data service plans.

6. The method of claim 1, further comprising receiving subscriber selection of a personalized data service plan contained in the personalized data service offer.

7. A method for enabling personalization of a data service plan, the method comprising:
communicating to a subscriber a data service generation offer;
receiving a communication from the subscriber indicating acceptance of the data service generation offer; and
in response to receiving the communication indicating acceptance of the data service generation offer, generating a personalized data service offer and presenting the personalized data service offer to the subscriber, wherein the personalized data service offer includes at least one persistent personalized data service plan.

8. The method of claim 7, wherein generating a personalized data service offer comprises using profile and network usage data of the subscriber to generate the personalized data service offer.

9. The method of claim 8, wherein the profile and network usage data comprises one or more of historical network usage of the subscriber, statistical network usage data of the subscriber, and current subscription information of the subscriber.

10. The method of claim 7, wherein presenting the personalized data service offer comprises displaying the personalized data service offer to the subscriber.

11. The method of claim 7, wherein the personalized data service offer defines a plurality of personalized data service plans.

12. The method of claim 7, further comprising receiving subscriber selection of the at least one personalized data service plan contained in the personalized data service offer.

13. The method of claim 12, further comprising, in response to receiving subscriber selection of the personalized data service offer, implementing the selected personalized data service plan as a persistent plan for the subscriber.

14. A method for enabling personalization of a data service plan, the method comprising:
receiving profile and network usage data of a subscriber;
generating a personalized data service offer for the subscriber based on the profile and network usage data, wherein the personalized data service offer defines a content filtering service for the subscriber; and
presenting the personalized data service offer and content filtering service to the subscriber.

15. The method of claim 14, further comprising receiving subscriber selection of a personalized data service plan contained in the personalized data service offer.

16. The method of claim 15, further comprising, in response to receiving subscriber selection, implementing the content filtering service for the subscriber.

17. The method of claim 14, further comprising defining the content filtering service based on one or more of historically-accessed network content, times of access, and content-filtering preferences of the subscriber.

18. The method of claim 17, wherein defining the content filtering services comprises defining the content filtering service based on web site accesses.

19. The method of claim 18, wherein defining the content filtering service is based on a categorization of the web sites that have been accessed.

20. A method for enabling personalization of a data service plan, the method comprising:
communicating to a subscriber a data service generation offer;
receiving a communication from the subscriber indicating acceptance of the data service generation offer; and
in response to receiving the communication indicating acceptance of the data service generation offer, triggering capture of network usage data of the subscriber.

21. The method of claim 20, further comprising:
generating a personalized data service offer based on the captured network usage data; and
presenting the personalized data service offer to the subscriber.

22. A method for enabling personalization of a data service plan, the method comprising:
receiving profile and network usage data of a subscriber;
generating a personalized data service offer for the subscriber based on the profile and network usage data, wherein the personalized data service offer defines limits on traffic associated with the peer-to-peer applications; and
presenting the personalized data service offer to the subscriber.

23. The method of claim 22, wherein the traffic associated with peer-to-peer applications includes one or more of peer-to-peer upstream traffic and peer-to-peer downstream traffic.

24. The method of claim 22, wherein the personalized data service offer specifies a trigger for controlling peer-to-peer traffic, and
wherein the method further comprises receiving subscriber response for triggering control of the peer-to-peer traffic.

25. A method for enabling personalization of a data service plan, the method comprising:
storing status information of a personalized data service offer for a subscriber; and
managing actions of network elements associated with the personalized data service offer by use of the stored status information.

26. The method of claim 25, wherein managing actions of network elements comprises one or more of authorizing, preparing, and presenting the personalized data service offer for the subscriber.

27. The method of claim 25, further comprising using at least one of the network elements for presenting the personalized data service offer to the subscriber.

28. A method for enabling personalization of a data service plan, the method comprising:
receiving profile and network usage data of a subscriber;
generating a set of personalized data service offerings to persistently modify a data subscription; and
presenting the offerings to a subscriber.

29. The method of claim 28, wherein the profile and network usage data comprises one or more of historical network usage of the subscriber, statistical network usage data of the subscriber, and current subscription information of the subscriber.

30. The method of claim 28, wherein generating the set of personalized data service offerings comprises using profile and network usage data of the subscriber to generate the set of personalized data service offerings.

31. A method for personalization of a data service plan, the method comprising:
determining an attempt at network access by a subscriber;
in response to determining the attempt at network access, redirecting the subscriber to a portal for presentation of one of a personalized data service offer and an offer to generate a personalized data service offer.

32. The method of claim 31, wherein the attempt at network access is an attempt at Internet access.

33. The method of claim 31, further comprising presenting to the subscriber one of the personalized data service offer and the offer to generate a personalized data service offer.

34. The method of claim 31, further comprising:
communicating to the subscriber a data service generation offer;
receiving a communication from the subscriber indicating acceptance of the data service generation offer; and
in response to receiving the communication indicating acceptance of the data service generation offer, generating the personalized data service offer and presenting the personalized data service offer to the subscriber.

35. A system for enabling personalization of a data service plan, the system comprising:
at least a processor and memory configured to:
receive profile and network usage data of a subscriber;
automatically generate a personalized data service offer for the subscriber based on the profile and network usage data; and
automatically present the personalized data service offer to the subscriber.

36. The system of claim 35, wherein the at least a processor and memory are configured to store the personalized data service offer for subsequent presentation to the subscriber.

37. The system of claim 35, wherein the at least a processor and memory are configured to display the personalized data service offer to the subscriber.

38. The system of claim 35, wherein the profile and network usage data comprises one or more of historical network usage of the subscriber, statistical network usage data of the subscriber, and current subscription information of the subscriber.

39. The system of claim 35, wherein the personalized data service offer defines a plurality of personalized data service plans.

40. The system of claim 35, wherein the at least a processor and memory are configured to receive subscriber selection of a personalized data service plan contained in the personalized data service offer.

41. A system for enabling personalization of a data service plan, the system comprising:
at least a processor and memory configured to:
communicate to a subscriber a data service generation offer;
receive a communication from the subscriber indicating acceptance of the data service generation offer; and
generate a personalized data service offer and presenting the personalized data service offer to the subscriber in response to receiving the communication indicating acceptance of the data service generation offer, wherein the personalized data service offer includes at least one persistent personalized data service plan.

42. The system of claim 41, wherein the at least a processor and memory are configured to use profile and network usage data of the subscriber to generate the personalized data service offer.

43. The system of claim 42, wherein the profile and network usage data comprises one or more of historical network usage of the subscriber, statistical network usage data of the subscriber, and current subscription information of the subscriber.

44. The system of claim 41, wherein the at least a processor and memory are configured to display the personalized data service offer to the subscriber.

45. The system of claim 41, wherein the personalized data service offer defines a plurality of personalized data service plans.

46. The system of claim 41, wherein the at least a processor and memory are configured to receive subscriber selection of the at least one personalized data service plan contained in the personalized data service offer.

47. The system of claim 46, wherein the at least a processor and memory are configured to implement the selected personalized data service plan as a persistent plan for the subscriber in response to receiving subscriber selection of the personalized data service offer.

48. A system for enabling personalization of a data service plan, the system comprising:
at least a processor and memory configured to:
receive profile and network usage data of a subscriber;
generate a personalized data service offer for the subscriber based on the profile and network usage data, wherein the personalized data service offer defines a content filtering service for the subscriber; and
present the personalized data service offer and content filtering service to the subscriber.

49. The system of claim 48, wherein the at least a processor and memory are configured to receive subscriber selection of a personalized data service plan contained in the personalized data service offer.

50. The system of claim 49, wherein the at least a processor and memory are configured to implement the content filtering service for the subscriber in response to receiving subscriber selection.

51. The system of claim 48, wherein the at least a processor and memory are configured to define the content filtering service based on one or more of historically-accessed network content, times of access, and content-filtering preferences of the subscriber.

52. The system of claim 51, wherein the at least a processor and memory are configured to define the content filtering service based on web site accesses.

53. A system for enabling personalization of a data service plan, the system comprising:
at least a processor and memory configured to:
communicate to a subscriber a data service generation offer;
receive a communication from the subscriber indicating acceptance of the data service generation offer; and
trigger capture of network usage data of the subscriber in response to receiving the communication indicating acceptance of the data service generation offer.

54. The system of claim 53, wherein the at least a processor and memory are configured to:
generate a personalized data service offer based on the captured network usage data; and
present the personalized data service offer to the subscriber.

55. A system for enabling personalization of a data service plan, the system comprising:
at least a processor and memory configured to:
receive profile and network usage data of a subscriber;
generate a personalized data service offer for the subscriber based on the profile and network usage data, wherein the personalized data service offer defines limits on traffic associated with peer-to-peer applications; and
present the personalized data service offer to the subscriber.

56. The system of claim 55, wherein the traffic associated with peer-to-peer applications includes one or more of peer-to-peer upstream traffic and peer-to-peer downstream traffic.

57. The system of claim 55, wherein the personalized data service offer specifies a trigger for controlling peer-to-peer traffic, and
wherein the at least a processor and memory are configured to receive subscriber response for triggering control of the peer-to-peer traffic.

58. A system for enabling personalization of a data service plan, the system comprising:
at least a processor and memory configured to:
store status information of a personalized data service offer for a subscriber; and
manage actions of network elements associated with the personalized data service offer by use of the stored status information.

59. The system of claim 58, wherein the actions include one or more of authorize, prepare, and present the personalized data service offer for the subscriber.

60. The system of claim 58, wherein the at least a processor and memory are configured to use at least one of the network elements for presenting the personalized data service offer to the subscriber.

61. A system for enabling personalization of a data service plan, the system comprising:
at least a processor and memory configured to:
receive profile and network usage data of a subscriber;
generate a set of personalized data service offerings to persistently modify a data subscription; and
present the offerings to a subscriber.

62. The system of claim 61, wherein the profile and network usage data comprises one or more of historical network usage of the subscriber, statistical network usage data of the subscriber, and current subscription information of the subscriber.

63. The system of claim 61, wherein the at least a processor and memory are configured to use profile and network usage data of the subscriber to generate the set of personalized data service offerings.

64. A system for personalization of a data service plan, the system comprising:
at least a processor and memory configured to:
determine an attempt at network access by a subscriber;
redirect the subscriber to a portal, for presentation of one of a personalized data service offer and an offer to generate a personalized data service offer, in response to determining the attempt at network access.

65. The system of claim 64, wherein the attempt at network access is an attempt at Internet access.

66. The system of claim 64, wherein the at least a processor and memory are configured to present to the subscriber one of the personalized data service offer and the offer to generate a personalized data service offer.

68. The system of claim 64, wherein the at least a processor and memory are configured to:
communicate to the subscriber a data service generation offer;
receive a communication from the subscriber indicating acceptance of the data service generation offer; and
generate the personalized data service offer and presenting the personalized data service offer to the subscriber in response to receiving the communication indicating acceptance of the data service generation offer.

69. A non-transitory computer readable medium having stored thereon computer executable instructions that when executed by the processor of a computer perform steps comprising:
receiving profile and network usage data of a subscriber;
automatically generating a personalized data service offer for the subscriber based on the profile and network usage data; and
automatically presenting the personalized data service offer to the subscriber.

70. A non-transitory computer readable medium having stored thereon computer executable instructions that when executed by the processor of a computer perform steps comprising:
communicating to a subscriber a data service generation offer;
receiving a communication from the subscriber indicating acceptance of the data service generation offer; and
in response to receiving the communication indicating acceptance of the data service generation offer, generating a personalized data service offer and presenting the personalized data service offer to the subscriber, wherein the personalized data service offer includes at least one persistent personalized data service plan.

71. A non-transitory computer readable medium having stored thereon computer executable instructions that when executed by the processor of a computer perform steps comprising:
receiving profile and network usage data of a subscriber;
generating a personalized data service offer for the subscriber based on the profile and network usage data, wherein the personalized data service offer defines a content filtering service for the subscriber; and
presenting the personalized data service offer and content filtering service to the subscriber.

72. A non-transitory computer readable medium having stored thereon computer executable instructions that when executed by the processor of a computer perform steps comprising:
communicating to a subscriber a data service generation offer;
receiving a communication from the subscriber indicating acceptance of the data service generation offer; and
in response to receiving the communication indicating acceptance of the data service generation offer, triggering capture of network usage data of the subscriber.

73. A non-transitory computer readable medium having stored thereon computer executable instructions that when executed by the processor of a computer perform steps comprising:
receiving profile and network usage data of a subscriber;
generating a personalized data service offer for the subscriber based on the profile and network usage data, wherein the personalized data service offer defines limits on traffic associated with peer-to-peer applications; and
presenting the personalized data service offer to the subscriber.

74. A non-transitory computer readable medium having stored thereon computer executable instructions that when executed by the processor of a computer perform steps comprising:
storing status information of a personalized data service offer for a subscriber; and
managing actions of network elements associated with the personalized data service offer by use of the stored status information.

75. A non-transitory computer readable medium having stored thereon computer executable instructions that when executed by the processor of a computer perform steps comprising:
receiving profile and network usage data of a subscriber;
generating a set of personalized data service offerings to persistently modify a data subscription; and
presenting the offerings to a subscriber.

76. A non-transitory computer readable medium having stored thereon computer executable instructions that when executed by the processor of a computer perform steps comprising:
determining an attempt at network access by a subscriber;
in response to determining the attempt at network access, redirecting the subscriber to a portal for presentation of one of a personalized data service offer and an offer to generate a personalized data service offer.
